(19) United States
(12) Patent Application Publication
(10) Pub. No.: US 2002/0055312 A1
(43) Pub. Date: May 9, 2002

(54) Textile composition

(76) Inventor: Jeffrey M. Beraznik, Phoenix, AZ (US)

Correspondence Address: Michael W. Goltry, PARSONS & GOLTRY, Suite 260, 340 East Palm Lane, Phoenix, AZ, 85004, US

(21) Appl. No.: 10/026,193

(22) Filed: Dec. 21, 2001

Related U.S. Application Data
(62) Division of application No. 09/361,871, filed on Jul. 27, 1999.

(51) Int. Cl. B32B 5/02

(52) U.S. Cl. 442/63; 442/153; 156/307.3

(57) ABSTRACT

A textile composition for use in constructing useful garments, the textile composition comprising united superimposed layers of a plastisol composition, a primer and a pliant, stretchable fabric.

### FIELD OF THE INVENTION

This invention relates to textiles and, more particularly, to a pliant, stretchable textile composition.

### BACKGROUND OF THE INVENTION

The term textile refers to any filament, fiber or yarn that can be made into fabric or cloth, and the resulting material itself. The word textile originally referred to only woven fabrics but now includes knitted, bonded, felted, and tufted fabrics as well. The fundamental raw materials used in textile production are fibers, either those obtained from natural resources, such as wool from sheep, or those produced from chemical substances. After converting raw material into fabric, it is subject to various mechanical and chemical finishing processes for removing defects, foreign matter and moisture. Treatments such as napping, shearing, pressing, brushing, and polishing are used to improve fabric appearance and enhance tactile qualities. Other steps in textile production include printing (the imposition of a decorative pattern) or the application of pigment or dye. In addition to widespread industrial use, textiles are used for wearing apparel, household linens and bedding, upholstery, draperies and curtains, wall coverings, rugs and carpets, and bookbindings.

A specific class of wearing apparel is sport gloves, which includes golf gloves, batting gloves, football gloves, hockey gauntlets, water-skiing gloves, etc. Sport gloves normally exhibit a tacky or somewhat tacky or sticky exterior for enhancing gripping ability. The materials used for constructing commercially available sport gloves, however, normally wear out quickly, and do not provide particularly good grip enhancement characteristics. To improve sport gloves and other similar garments, there is a need for improving not only the manufacture of specialized textiles for use in constructing sport gloves, but also the structure of specialized textiles for enhancing dexterity, functionality, comfort and gripping ability.

Accordingly, it would be highly desirable to provide a new and improved textile composition for use in constructing useful garments such as batting gloves, golf and football gloves, hockey gauntlets, water-skiing gloves, etc.

It is a purpose of the invention to provide a new and improved textile composition that is easy to make.

It is another purpose of the invention to provide a new and improved textile composition that is relatively inexpensive.

It is still another purpose of the invention to provide a new and improved textile composition that is rugged, flexible and resilient.

It is a further purpose of the invention to provide a new and improved sporting glove constructed of a textile composition that is comfortable and flexible, and exhibits exemplary dexterity and gripping ability.

### SUMMARY OF THE INVENTION

The above problems and others are at least partially solved and the above purposes and others realized in a new and improved pliant, stretchable textile composition comprising united superimposed layers of a plastisol composition, a primer and a pliant, stretchable fabric. The primer composition may comprise polyurethane or other similar substance that when provided in the form of a layer or coat of varying thickness, is pliant, strechable, flexible and resilient. The stretchable fabric may comprise polyester, cotton, a cotton/polyester blend, or other similar material constructed so as to be pliant and strechable.

Consistent with the foregoing, the invention also includes associated methods.

### BRIEF DESCRIPTION OF THE DRAWINGS

The foregoing and further and more specific objects and advantages of the invention will become readily apparent to those skilled in the art from the following detailed description taken in conjunction with the drawings in which:

FIG. 1 is a perspective view of a textile composition comprising united superimposed layers of a plastisol composition, a primer and a pliant, stretchable fabric, in accordance with the invention;

FIG. 2 is a sectional view taken along line 2-2 of FIG. 1;

FIG. 3 is a perspective view of a viscous plastisol composition being sprayed onto a layer of a primer united to a pliant, stretchable fabric;

FIG. 4 is a perspective view of a substrate comprising united superimposed layers of a primer and a pliant, stretchable fabric being dipped into a viscous plastisol composition;

FIG. 5 is a perspective view of a substrate comprising united superimposed layers of a primer and a pliant, stretchable fabric shown supported in the form of source and take-up rolls, with a viscous plastisol composition shown being sprayed onto the primer of the substrate supported between the source and take-up rolls;

FIG. 6 is a perspective view of a plastisol composition being laminated onto a layer of a primer united to a pliant, stretchable fabric; and

FIG. 7 is a perspective view of gloves constructed of the textile composition of FIG. 1, the gloves shown as they would appear worn by a user gripping a bat.

### DETAILED DESCRIPTION OF A PREFERRED EMBODIMENT

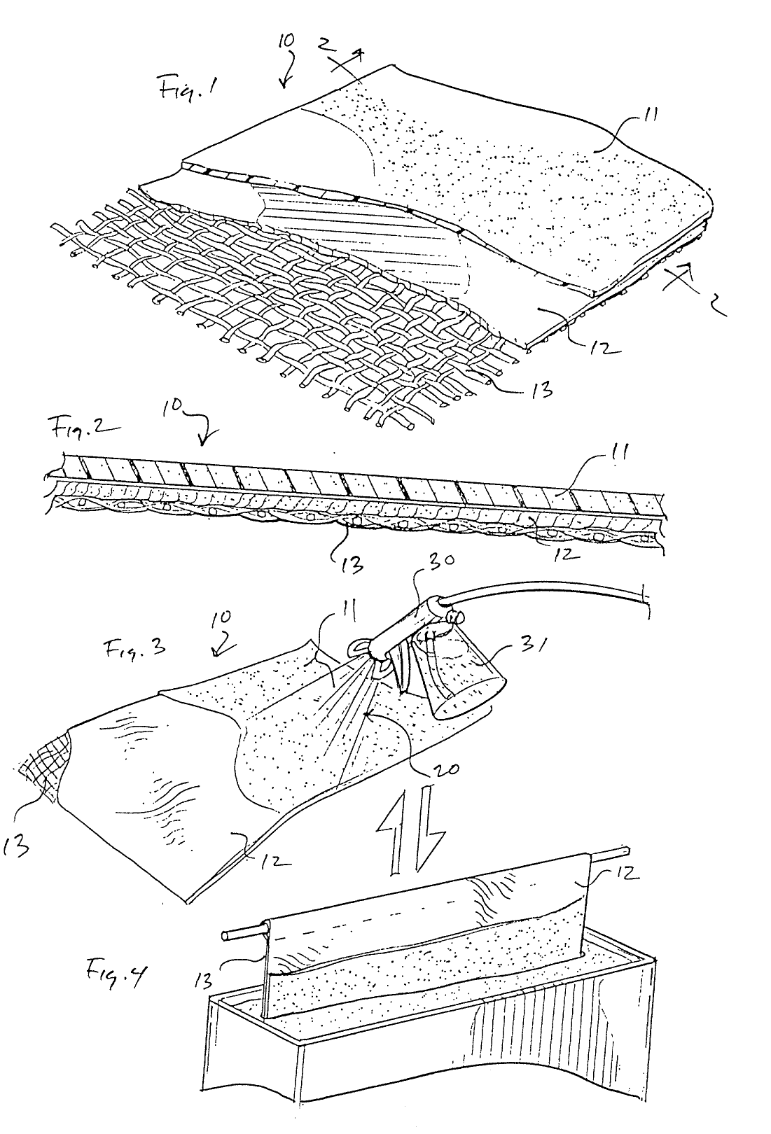

Turning to the drawings, in which like reference characters indicate corresponding elements throughout the several views, FIGS. 1 and 2 show perspective and sectional views, respectively, of a pliant, stretchable textile composition 10 comprising united superimposed layers of a plastisol composition 11, a primer 12 and a pliant, stretchable fabric 13, in accordance with the invention. Fabric 13 is preferably constructed of cotton and/or polyester fibers woven, knitted, bonded, felted, or tufted together so as to be flexible or stretchable. Fabric 13 is shown as it would appear woven only for the purpose of illustration. Other pliant, stretchable fabrics may be used with the invention if desired.

In texture, fabric 13 is soft and absorbent. Although the fabric 13 and primer 12 are preferably discrete united layers, the primer 12 may be applied to partially or totally enclose, engulf or impregnate the fabric 13 layer if desired. Like fabric 13, the primer 12 and plastisol composition 11 layers have inherent resiliency and flexibility. In texture, the plastisol composition 11 is tacky. In view of the overall flexibility or stretchability of textile composition 10, the soft, absorbent quality of the fabric 13 layer, and the tacky tactile quality of the plastisol composition 11 layer, textile composition 10 proves particularly useful for constructing sport gloves such as golf gloves, football gloves, hockey gauntlets, water-skiing gloves, batting gloves 14 shown in FIG. 7 as they would appear worn by a user gripping a baseball bat 15, etc. With fabric 13 layer directed against the user's skin and plastisol composition 11 exposed, gloves 14 are comfortable and light against the user's skin, stretch easily during use, and provide exemplary tactile and gripping ability.

Primer 12 may be comprised of polyurethane or other similar material that when formed into a layer or coat of varying thickness, is flexible, strechable, pliant and resilient. Whether fabric 13 is constructed of cotton and/or polyester, the united superimposed layers of fabric 13 and primer 12 may comprise one of a variety of commercially available substrates. To complete the formation of textile composition 10, the plastisol composition 11 must be heated and provided in viscous or partially viscous form, coated onto the primer 12 layer, and then cured. Primer 12 layer is substantially impermeable to plastisol composition 11. As a result, when applied to primer 12 layer as one or more coatings, the plastisol composition 11 will not pass through primer 12 layer into fabric 13. When cured, the plastisol composition 11 is tacky and flexible or stretchable. Because primer 12 layer is impermeable to the plastisol composition 11 which, of course, prevents plastisol composition 11 from curing in or on the fabric 13 layer, the final textile composition 10 is very light and exhibits exemplary dexterity. The final thickness of the layer of plastisol composition 11 may be easily and specifically controlled by controlling the viscosity of the plastisol composition 11 as it is being applied, by allowing excess plastisol composition 11 to drain off after application, or perhaps by exposing the applied layer to centripetal or spinning forces.

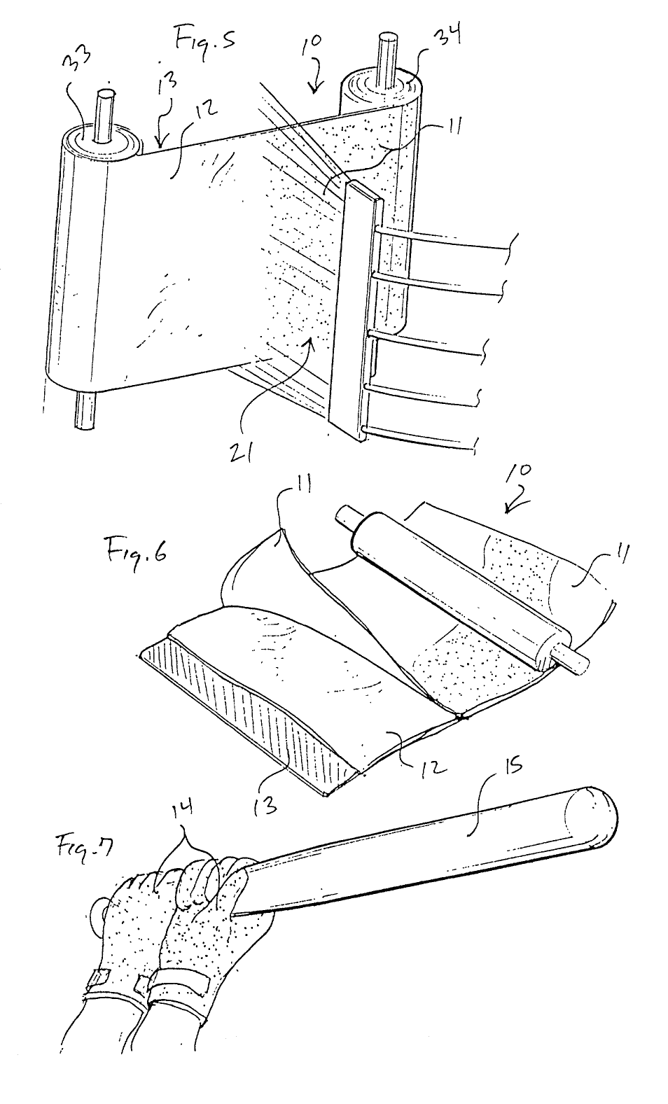

Consistent with the ensuing embodiments, one or more layers of plastisol composition 11 may be applied by repeating coating application steps depending on desired thickness. By application of heat, plastisol composition 11 may be rendered viscous and then applied by spraying, spreading, rolling, dipping, etc. Regarding a specific embodiment, viscous plastisol composition 11 may be coated onto the layer of polyurethane in the form of a spray shown in FIGS. 3 and 5 by the reference characters 20 and 21, respectively. Regarding the embodiment of FIG. 3, plastisol composition 11 is shown being sprayed onto the polyurethane layer 12 layer with a conventional spray nozzle 30 coupled in liquid communication with a source 31 of viscous plastisol composition. In FIG. 5, the substrate of superimposed layers of primer 12 and fabric 13 is shown supported between source 33 and take-up 34 rolls, with viscous plastisol composition 11 shown being sprayed onto the primer 12 of the substrate supported between the source 33 and take-up 34 rolls. In another embodiment shown in FIG. 4, the substrate of superimposed layers of primer 12 and fabric 13 is shown being dipped into a receptacle 22 containing viscous plastisol composition 11 so that when removed, leaves a coat of the plastisol composition 11 on the primer 12 layer. To protect the fabric 13 layer from becoming coated when dipped, it may be concealed with an adhesive backing before the dipping operation, and then removed after dipping. The substrate of superimposed layers of primer 12 and fabric 13 may, alternatively, by mounted onto a mandrel or fixture in a manner to leave only the primer 12 layer exposed, which will facilitate deposition of a coat only on primer 12 layer when exposed or dipped into viscous plastisol composition 11. Regarding the embodiment in FIG. 6, a sheet of plastisol composition 11 is shown as it would appear being laminated onto the layer of primer 12 in a conventional manner with the application of heat. After one or more coatings or layers of viscous plastisol composition 11 is applied, it must be cured by heating the viscous composition layer 11 in an oven having a temperature of at least 185 degrees centigrade for a duration of at least five minutes.

Plastisol composition 11 comprises any one of a variety of commercially available resin/plasticizer mixtures that can be made into a continuous film upon application of heat. In the interest of disclosure regarding a specific but not essential or limiting embodiment, plastisol composition 11 may include one or more of the following components including (1) 36-42 percent by weight of a high molecular weight polyvinylchloride homo-polymer resin; (2) 28-37 percent by weight of Di-2-ethyl hexyl phthalate; (3) 14-21 percent by weight of butyl benzyl phthalate; (4) 3.6-8.3 percent by weight of 2,2,4-trimethyl-1,3-pentanediol diisobutyrate; (5) 1.8-2.1 percent by weight of epoxydised soya bean oil; and (6) 0.36-0.83 percent by weight of a calcium-zinc complex soap. White spirit or other suitable solvent may be added purely as a viscosity controller, which will evaporate completely during the curing process.

The invention has been described above with reference to one or more preferred embodiments. However, those skilled in the art will recognize that changes and modifications may be made in the described embodiments without departing from the nature and scope of the invention. Various changes and modifications to one or more of the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A pliant, stretchable textile composition comprising united superimposed layers of a plastisol composition, a primer and a pliant, stretchable fabric.

2. The textile composition of claim 1, wherein the primer comprises polyurethane.

3. The textile composition of claim 1, wherein the pliant, stretchable fabric comprises polyester fabric.

4. The textile composition of claim 1, wherein the pliant, stretchable fabric comprises cotton fabric.

5. A method of manufacturing a textile composition comprising the steps of:
providing a pliant, stretchable fabric coated with a pliant, strechable primer;
coating the primer with at least one layer of a viscous plastisol composition; and
curing the layer.

6. The method of claim 5, wherein the step of coating further includes the step of spraying.

7. The method of claim 5, wherein the step of coating further includes the step of laminating.

8. The method of claim 5, wherein the step of coating further includes the step of spreading.

9. The method of claim 5, wherein the step of curing further includes the step of heating the layer in an oven having a temperature of at least 185 degrees centigrade for a duration of at least five minutes.

10. The method of claim 5, wherein the step of providing a pliant, stretchable fabric coated with a pliant, strechable primer further includes the step of providing polyester fabric coated with polyurethane.

11. The method of claim 5, wherein the step of providing a pliant, stretchable fabric coated with a pliant, strechable primer further includes the step of providing cotton fabric coated with polyurethane.

12. In united, superimposed layers of a pliant, stretchable fabric and a pliant, strechable primer substantially impermeable to a plastisol composition, a method of binding a plastisol composition to the primer comprising the steps of:
coating the primer with at least one layer of a viscous plastisol composition; and
curing the layer.

13. The method of claim 12, wherein the step of coating further includes the step of spraying.

14. The method of claim 12, wherein the step of coating further includes the step of laminating.

15. The method of claim 12, wherein the step of coating further includes the step of spreading.

16. The method of claim 12, wherein the step of curing further includes the step of heating the layer in an oven having a temperature of at least 185 degrees centigrade for a duration of at least five minutes.
